(19) United States
(12) Patent Application Publication
(10) Pub. No.: US 2025/0338274 A1
(43) Pub. Date: Oct. 30, 2025

(54) DEMODULATION REFERENCE SIGNAL-BASED TWO-PART HYBRID AUTOMATIC REPEAT REQUEST FEEDBACK

(71) Applicant: QUALCOMM Incorporated, San Diego, CA (US)

(72) Inventors: Mostafa KHOSHNEVISAN, San Diego, CA (US); Jing JIANG, San Diego, CA (US); Wei YANG, San Diego, CA (US); Jing SUN, San Diego, CA (US)

(21) Appl. No.: 18/647,872

(22) Filed: Apr. 26, 2024

(51) Int. Cl. H04W 72/1273; H04L 1/1812; H04L 5/00; H04W 72/21

(52) U.S. Cl. CPC H04W 72/1273; H04L 1/1812; H04L 5/0051; H04W 72/21

(57) ABSTRACT

Methods, systems, and devices for wireless communications are described. A user equipment (UE) may use a demodulation reference signal (DMRS) sequence transmitted via a physical uplink control channel (PUCCH) to indicate a first part of two-part hybrid automatic repeat request (HARQ) feedback. As the network entity may decode a DMRS sequence in order to decode the PUCCH transmission (e.g., the control resource elements (REs) of the PUCCH) the network entity may decode the DMRS and accordingly determine the part one of the two-part HARQ feedback prior to decoding the part two of the two-part HARQ feedback. For example, different DMRS sequence types, hopping identifiers (IDs), cyclic shifts, or initialization values (e.g., scrambling IDs) may be configured for different values of part one of the two-part HARQ feedback, and accordingly, a UE may indicate the part one value of the two-part HARQ feedback using the DMRS sequence of the PUCCH.

### FIELD OF TECHNOLOGY

The following relates to wireless communications, including demodulation reference signal (DMRS)-based two-part hybrid automatic repeat request (HARQ) feedback.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more downlink shared channel messages and transmitting a control message via an uplink control channel communication that includes one or more demodulation reference signals (DMRSs) in accordance with a DMRS sequence, where the DMRS sequence is indicative of a first part of a two-part hybrid automatic repeat request (HARQ) feedback associated with the one or more downlink shared channel messages, and where the first part of the two-part HARQ feedback is indicative of a size of a second part of the two-part HARQ feedback.

A UE for wireless communications is described. The UE may include one or more memories storing processor executable code, and one or more processors coupled with the one or more memories. The one or more processors may individually or collectively be operable to execute the code to cause the UE to receive one or more downlink shared channel messages and transmit a control message via an uplink control channel communication that includes one or more DMRSs in accordance with a DMRS sequence, where the DMRS sequence is indicative of a first part of a two-part HARQ feedback associated with the one or more downlink shared channel messages, and where the first part of the two-part HARQ feedback is indicative of a size of a second part of the two-part HARQ feedback.

Another UE for wireless communications is described. The UE may include means for receiving one or more downlink shared channel messages and means for transmitting a control message via an uplink control channel communication that includes one or more DMRSs in accordance with a DMRS sequence, where the DMRS sequence is indicative of a first part of a two-part HARQ feedback associated with the one or more downlink shared channel messages, and where the first part of the two-part HARQ feedback is indicative of a size of a second part of the two-part HARQ feedback.

A non-transitory computer-readable medium storing code for wireless communications is described. The code may include instructions executable by one or more processors to receive one or more downlink shared channel messages and transmit a control message via an uplink control channel communication that includes one or more DMRSs in accordance with a DMRS sequence, where the DMRS sequence is indicative of a first part of a two-part HARQ feedback associated with the one or more downlink shared channel messages, and where the first part of the two-part HARQ feedback is indicative of a size of a second part of the two-part HARQ feedback.

Some examples of the method, UEs, and non-transitory computer-readable medium described herein may further include operations, features, means, or instructions for transmitting, via the control message, the second part of the two-part HARQ feedback.

In some examples of the method, UEs, and non-transitory computer-readable medium described herein, transmitting the control message may include operations, features, means, or instructions for transmitting the control message including a set of control resource elements (REs), where the second part of the two-part HARQ feedback may be jointly encoded on the set of control REs with a scheduling request (SR) or channel state information (CSI) feedback, or both.

In some examples of the method, UEs, and non-transitory computer-readable medium described herein, transmitting the control message may include operations, features, means, or instructions for transmitting a first part of the control message including a first set of control REs that include the second part of the two-part HARQ feedback, where the second part of the two-part HARQ feedback may be jointly encoded on the first set of control REs with a SR or a first part of two-part CSI feedback, or both and transmitting a second part of the control message including a second set of control REs that include a second part of the two-part CSI feedback.

In some examples of the method, UEs, and non-transitory computer-readable medium described herein, transmitting the control message may include operations, features, means, or instructions for transmitting a first part of the control message including a first set of control REs that include a first part of two-part CSI feedback, where the first part of the two-part CSI feedback may be jointly encoded on the first set of control REs with a SR and transmitting a second part of the control message including a second set of control REs that include the second part of the two-part HARQ feedback, where the second part of the two-part HARQ feedback may be jointly encoded on the second set of control REs with a second part of the two-part CSI feedback.

In some examples of the method, UEs, and non-transitory computer-readable medium described herein, the DMRS sequence may be indicative of the first part of the two-part HARQ feedback based on the DMRS sequence being a first sequence type of a set of candidate sequence types, having a first cyclic shift of a set of candidate cyclic shifts, having a first hopping identifier of a set of candidate hopping identifiers, being associated with an initialization identifier of a set of candidate initialization identifiers, or having a first scrambling identifier of a set of candidate scrambling identifiers.

Some examples of the method, UEs, and non-transitory computer-readable medium described herein may further include operations, features, means, or instructions for receiving control signaling that indicates a mapping of a set of values associated with the first part of the two-part HARQ feedback to the set of candidate sequence types, the set of candidate cyclic shifts, the set of candidate hopping identifiers, the set of candidate initialization identifiers, or the set of candidate scrambling identifiers, or any combination thereof, where transmission of the control message via the uplink control channel communication may be based on the control signaling.

In some examples of the method, UEs, and non-transitory computer-readable medium described herein, the control signaling indicates the mapping for a component carrier, for an uplink control channel configuration, for an uplink control channel format, or for an uplink control channel resource and the uplink control channel communication may be associated with the component carrier, the uplink control channel configuration, the uplink control channel format, or the uplink control channel resource.

Some examples of the method, UEs, and non-transitory computer-readable medium described herein may further include operations, features, means, or instructions for transmitting, via the uplink control channel communication, the one or more DMRSs via a set of two or more REs separated in frequency from each other by one or more other null REs, where the first part of the two-part HARQ feedback indicates that the size of the second part of the two-part HARQ feedback may be zero, and where the set of two or more REs may be transmitted using a transmission power that may be based on the size of the second part of the two-part HARQ feedback being zero.

Some examples of the method, UEs, and non-transitory computer-readable medium described herein may further include operations, features, means, or instructions for refraining from transmitting a set of control REs in the uplink control channel communication based on the first part of the two-part HARQ feedback indicating that the size of the second part of the two-part HARQ feedback may be zero.

Some examples of the method, UEs, and non-transitory computer-readable medium described herein may further include operations, features, means, or instructions for transmitting, via the uplink control channel communication, the one or more DMRSs via a set of two or more REs in a same symbol, where the first part of the two-part HARQ feedback indicates that the size of the second part of the two-part HARQ feedback may be zero.

Some examples of the method, UEs, and non-transitory computer-readable medium described herein may further include operations, features, means, or instructions for refraining from transmitting the one or more DMRSs in a symbol of the uplink control channel communication other than the same symbol based on the size of the second part of the two-part HARQ feedback being zero.

Some examples of the method, UEs, and non-transitory computer-readable medium described herein may further include operations, features, means, or instructions for using the DMRS sequence to indicate the first part of the two-part HARQ feedback may be based on a size of a HARQ feedback codebook associated with the one or more downlink shared channel messages, a size of the first part of the two-part HARQ feedback, one or more resources associated with the uplink control channel communication, a format of the uplink control channel communication, a priority of the HARQ feedback codebook, whether the control message includes a SR, whether the control message includes CSI feedback, or a combination thereof.

Some examples of the method, UEs, and non-transitory computer-readable medium described herein may further include operations, features, means, or instructions for receiving control signaling that configures the UE to indicate the first part of the two-part HARQ feedback via the DMRS sequence, where transmission of the control message via the uplink control channel communication may be based on the control signaling.

Some examples of the method, UEs, and non-transitory computer-readable medium described herein may further include operations, features, means, or instructions for transmitting capability signaling that indicates a capability of the UE to use the DMRS sequence to indicate the first part of the two-part HARQ feedback, where transmission of the control message via the uplink control channel communication may be based on the capability signaling.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports demodulation reference signal (DMRS)-based two-part hybrid automatic repeat request (HARQ) feedback in accordance with one or more aspects of the present disclosure.

FIG. 2 shows an example of a wireless communications system that supports DMRS-based two-part HARQ feedback in accordance with one or more aspects of the present disclosure.

FIG. 3 shows an example of an encoding diagram that supports DMRS-based two-part HARQ feedback in accordance with one or more aspects of the present disclosure.

FIG. 4 shows an example of a resource diagram that supports DMRS-based two-part HARQ feedback in accordance with one or more aspects of the present disclosure.

FIG. 5 shows an example of an encoding diagram that supports DMRS-based two-part HARQ feedback in accordance with one or more aspects of the present disclosure.

FIG. 6 shows an example of a process flow that supports DMRS-based two-part HARQ feedback in accordance with one or more aspects of the present disclosure.

FIGS. 7 and 8 show block diagrams of devices that support DMRS-based two-part HARQ feedback in accordance with one or more aspects of the present disclosure.

FIG. 9 shows a block diagram of a communications manager that supports DMRS-based two-part HARQ feedback in accordance with one or more aspects of the present disclosure.

FIG. 10 shows a diagram of a system including a device that supports DMRS-based two-part HARQ feedback in accordance with one or more aspects of the present disclosure.

FIG. 11 shows a flowchart illustrating methods that support DMRS-based two-part HARQ feedback in accordance with one or more aspects of the present disclosure.

### DETAILED DESCRIPTION

Various aspects relate generally to wireless communication and more particularly to use of a demodulation reference signal (DMRS) sequence transmitted via a physical uplink control channel (PUCCH) to indicate a first part (e.g., part one) of two-part hybrid automatic repeat request (HARQ) feedback. For example, as the network entity may decode a DMRS sequence to decode the PUCCH transmission (e.g., the control resource elements (REs) of the PUCCH) the network entity may decode the DMRS and accordingly determine the part one of the two-part HARQ feedback prior to decoding the part two of the two-part HARQ feedback. For example, different DMRS sequence types, hopping identifiers (IDs), cyclic shifts, or initialization values (e.g., scrambling IDs) may be configured for different values of part one of the two-part HARQ feedback, and accordingly, a user equipment (UE) may indicate the part one value of the two-part HARQ feedback using the DMRS sequence of the PUCCH. In some aspects, the different possible values of part one of two-part HARQ feedback may be mapped to different candidate DMRS sequence types, hopping IDs, cyclic shifts, or initialization values via control signaling, such as radio resource control (RRC). In some aspects, the UE may multiplex scheduling requests (SRs) and/or channel state information (CSI) feedback with the part two of the two-part HARQ feedback via a PUCCH.

Particular aspects of the subject matter described in this disclosure can be implemented to realize one or more of the following potential advantages. In some examples, by using the DMRS sequence in a PUCCH to indicate part one of the two-part HARQ feedback, the amount of control resources used for HARQ feedback may be reduced. The first part of the two-part HARQ feedback may indicate the presence of the second part of the two-part HARQ feedback. And as the network entity decodes the DMRS sequence prior to decoding the control REs in a PUCCH, the UE may indicate via the DMRS sequence whether the PUCCH includes part two of the two-part HARQ feedback, and thus whether the network entity should decode control REs corresponding to the second part of the two-part HARQ feedback. By preconfiguring mappings of different values of part one of a two-part HARQ to the different DMRS sequence types, hopping IDs, cyclic shifts, or initialization values via control signaling, the network and the UE may use the DMRS sequence of a PUCCH to indicate part one of the two-part HARQ. By multiplexing other uplink control information (UCI), such as SRs and CSI on a PUCCH with the two-part HARQ feedback, the UE may reduce latency associated with such UCI and may more efficiently use uplink resources.

Aspects of the disclosure are initially described in the context of wireless communications systems. Aspects of the disclosure are further illustrated by and described with reference to encoding diagrams, resource diagrams, process flows, apparatus diagrams, system diagrams, and flowcharts that relate to DMRS-based two-part HARQ feedback.

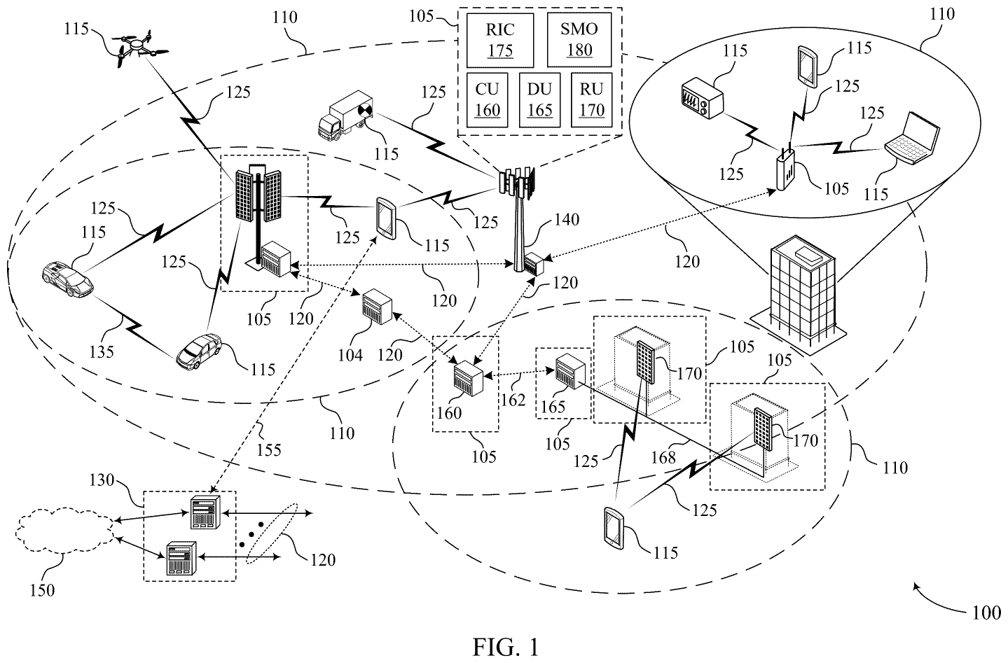

FIG. 1 shows an example of a wireless communications system 100 that supports DMRS-based two-part HARQ feedback in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, an RE may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an ID for distinguishing neighboring cells (e.g., a physical cell ID (PCID), a virtual cell ID (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may transmit HARQ feedback via a PUCCH (e.g., for one or more physical downlink shared channel (PDSCH) transmissions). In some examples, multiple PUCCH formats with different durations, payload size ranges, and multiplexing capabilities may be defined. For example, Table 1 shows the example configurations of five different PUCCH formats (Format 0, Format 1, Format 2, Format 3, and Format 4).

TABLE 1

| PUCCH | Length in Quantity | Quantity of | |
|---|---|---|---|
| Format | of OFDM Symbols | UCI Bits | Waveform |
| 0 | 1-2 | ≤2 | Computer |
| | | | generated sequence |
| | | | (CGS) |
| 1 | 4-14 | ≤2 | CGS |
| 2 | 1-2 | >2 | OFDM (1 or more |
| | | | resource blocks |
| | | | (RBs)) |
| 3 | 4-14 | >2 | DFT-S-OFDM (1 or |
| | | | more RBs) |
| 4 | 4-14 | >2 | DFT-S-OFDM |

With PUCCH format 2, each of the 1 or 2 OFDM symbol(s) may have DMRS with a frequency density of ⅓. With PUCCH format 3 or 4, all REs of some of the OFDM symbols may carry DMRS based on Table 2. Table 2 shows DMRS positions in OFDM symbols for PUCCH formats 3 and 4.

TABLE 2

| PUCCH | | | | |
|---|---|---|---|---|
| Length | DMRS Position l within PUCCH Span | | | |
| (OFDM | No additional DMRS | | Additional DMRS | |
| Symbols) | No Hopping | Hopping | No Hopping | Hopping |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

In NR, when a HARQ-acknowledgment (HARQ-ACK) codebook (CB) includes N bits, the 2^{N} codepoints may not be equally likely. For example, the block error ratio (BLER) target may be ≤10%, meaning ACKs may be more likely than negative ACKs (NACKs). Further, the 2^{N} codepoints may not be equally likely due to correlations in time, frequency, or layers (e.g., across slots, code block groups (CBGs), or transport blocks (TBs)). Because the 2^{N} codepoints may not be equally likely (e.g., may have different probabilities), compression may be possible to minimize the average HARQ-ACK payload size, which compression may be a source coding problem with optimal loss-less compression equal to entropy. Two-part HARQ feedback may be used to compress the feedback and minimize the average HARQ payload size. Two-part HARQ feedback may be analogous to two-part CSI in NR.

The network entity 105 that receives the PUCCH may decode part one of the two-part HARQ feedback to determine whether to decode (and how to decode) part two of the two-part HARQ feedback. For example, the size and interpretation of the second part of the two-part HARQ feedback may depend on the indicated codepoint (e.g., payload) of the first part. Two-part HARQ feedback may come close to optimal compression in terms of average length of the HARQ-ACK payload. In two-part HARQ feedback, the UE 115 may transmit the HARQ-ACK payload in two parts (part one and part two) that are separately encoded. Assuming the original HARQ-ACK CB has N bits, the part one has N₁ bits and part two has N₂ bits. N₁ may be fixed and may not be function of x^{N}, where x^{N} is the set of original HARQ-ACK bits before transformation into two-part HARQ feedback. For example, part one may have a fixed size for a given N. N₂ may be variable and may be a function of

$${x}_{1}^{{N}_{1}} ,$$

where

$${x}_{1}^{{N}_{1}}$$

are the part one HARQ bits after transformation of x^{N} to two-part HARQ feedback. Thus, part two has a variable length depending on part one. The network entity 105 may first decode part one, then may determine the length of part two, decode part two, and determine the original HARQ-ACK CB. For example, a simple form of two-part HARQ may include 4 HARQ-ACK bits with a BLER=10%. In such an example, 1 bit in part one may indicate whether all of the bits are ACKs (e.g., part one may be a “1” to indicate all ACKs and a “0” to indicate at least one NACK). In such examples, if a “1” is sent in part one, then part two may not be sent as part one indicates all bits are ACKs. In such examples, if a “0” is sent in part one, then four bits may be sent in part two to indicate the 4 ACK/NACKs. In such examples, with a BLER=10%, the overall payload size of two-part HARQ has a 0.6561 probability of being 1 bit and a 0.3439 probability of being 5 bits, and thus the two-part HARQ is 2.3756 bits on average, which is less than 4 bits if 4 ACK/NACKs are sent each time.

In the case that both part one and part two are multiplexed on the same PUCCH resource, and assuming that part one and part two are separately encoded, to avoid blind decoding at the network entity 105, part one should be decoded before part two based on the dependency of the size of part two on the payload of part one. In some examples, the set of control REs (excluding DMRS) of the PUCCH may be divided into two sets, where the first set of control REs carries the coded bits of part one and the second set of control REs carries coded bits of part two (such that part one may be decoded prior to part two).

As another example, the UE 115 may use the DMRS sequence transmitted via the PUCCH to indicate the part one of the two-part HARQ. For example, different DMRS sequences may be used for different part one HARQ-ACK payloads so that the network entity 105 may decode part one based on DMRS sequence detection. Part two HARQ-ACK coded bits may be sent using control REs of the PUCCH, but the control REs of the PUCCH may not be divided into two sets for HARQ-ACK purposes as part one may be indicated by the DMRS sequence. Given that the size of the part one of the HARQ-ACK payload may be small (e.g., 1-4 bits) compared to part one of a CSI report, sequence based part one HARQ-ACK may have a better performance compared to encoding part one (e.g., using short codes) and sending the encoded part one using part of the control REs (e.g., a first set of control REs) separate from the DMRS of the PUCCH. Further, the quantity of DMRS sequence that the network entity 105 may search to determine part one of the two-part HARQ may be small (e.g., as part one may include 1-4 bits) as compared to part one of a CSI report (which may be an impractical amount).

For example, different DMRS sequence types, hopping IDs, cyclic shifts, or initialization values (e.g., scrambling IDs) may be configured for different possible values of part one of the two-part HARQ feedback, and accordingly, a UE 115 may indicate the part one value of the two-part HARQ using the DMRS sequence of the PUCCH. In some examples, the different values of part one of a two-part HARQ may be mapped to the different DMRS sequence types (e.g., different DMRS base sequences), hopping IDs, cyclic shifts, or initialization values via control signaling, such as RRC (e.g., based on the component carrier, PUCCH configuration, PUCCH resource, or PUCCH format). The UE 115 may multiplex SR(s) and/or CSI feedback with the part two of the two-part HARQ feedback on a PUCCH.

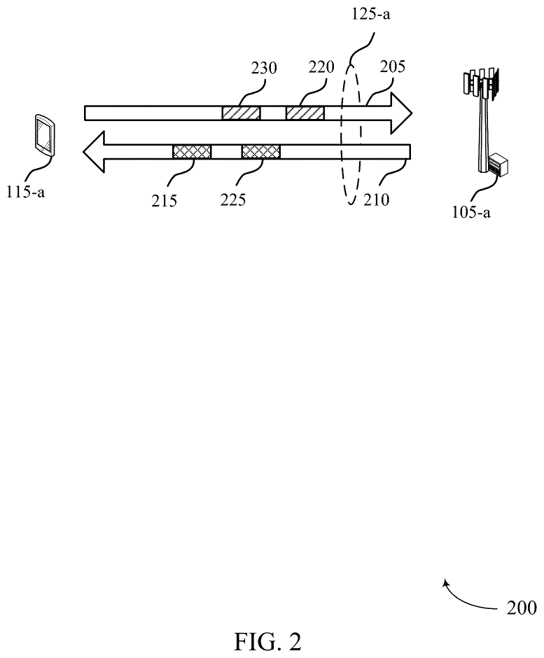

FIG. 2 shows an example of a wireless communications system 200 that supports DMRS-based two-part HARQ feedback in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. In some cases, the communication link 125-a may include an example of an access link (e.g., a Uu link). The communication link 125-a may include a bi-directional link that enables both uplink and downlink communication. For example, the UE 115-a may transmit uplink signals 205, such as uplink control signals or uplink data signals, to the network entity 105-a using the communication link 125-a, and the network entity 105-a may transmit downlink signals 210, such as downlink control signals or downlink data signals, to the UE 115-a using the communication link 125-a.

The network entity 105-a may transmit one or more downlink shared channel messages 225 (e.g., PDSCHs) to the UE 115-a. The UE 115-a may transmit a control message via an uplink control channel communication 230 (e.g., a PUCCH) that includes HARQ feedback for the one or more downlink shared channel messages 225. The UE 115-a may implement two-part HARQ feedback using a DMRS sequence to indicate part one of the two-part HARQ feedback as described herein. For example, the uplink control channel communication 230 may include one or more DMRS signals in accordance with a DMRS sequence, where the DMRS sequence indicates the part one of the two-part HARQ feedback. Based on the part one of the two-part HARQ feedback, the uplink control channel communication 230 may further include part two of the two-part HARQ feedback for the one or more downlink shared channel messages 225. In some examples, the UE 115-a may multiplex SRs and/or CSI feedback with the part two of the two-part HARQ feedback on the uplink control channel communication 230.

In some examples, under which conditions the UE 115-a may use a DMRS sequence to indicate part one of two-part HARQ feedback may be standardized or configurable. For example, the UE 115-a may use a DMRS sequence to indicate part one of two-part HARQ feedback based on one or more of the following: a size of the original HARQ-ACK codebook (e.g., N); the size of part one of two-part HARQ-ACK (N₁); the PUCCH resource that carries the HARQ-ACK; the PUCCH format that carries the HARQ-ACK; the priority of the HARQ-ACK codebook; and/or whether other UCIs (e.g., a CSI report and/or SR(s)) are multiplexed on the PUCCH. In some examples, the network entity 105-a may transmit control signaling 215 configuring the UE 115-a to use a DMRS sequence to indicate part one of two-part HARQ feedback. In some examples, the control signaling 215 may indicate the conditions when the UE 115-a should use a DMRS sequence to indicate part one of two-part HARQ feedback. For example, the control signaling 215 may be RRC, a MAC control element (MAC-CE), or downlink control information (DCI). In the case of RRC configuration, the use of a DMRS sequence to indicate part one of two-part HARQ feedback may be configured or enabled per component carrier, per PUCCH configuration, per PUCCH format, per PUCCH resource, or per PUCCH resource set. In some examples, the UE 115-a may transmit capability signaling 220 indicating the capability of the UE 115-a to use a DMRS sequence to indicate part one of two-part HARQ feedback, and the control signaling 215 may be responsive to or based on the capability signaling 220.

In some examples, the different values of part one of a two-part HARQ feedback may be mapped to the different DMRS sequence types, hopping IDs, cyclic shifts, or initialization values via the control signaling 215. Accordingly, the UE 115-a may indicate part one of the two-part HARQ feedback in the uplink control channel communication 230 using a type of DMRS sequence (e.g., a base sequence), a hopping ID, a cyclic shift, or an initialization value in accordance with the mapping indicated by the control signaling 215.

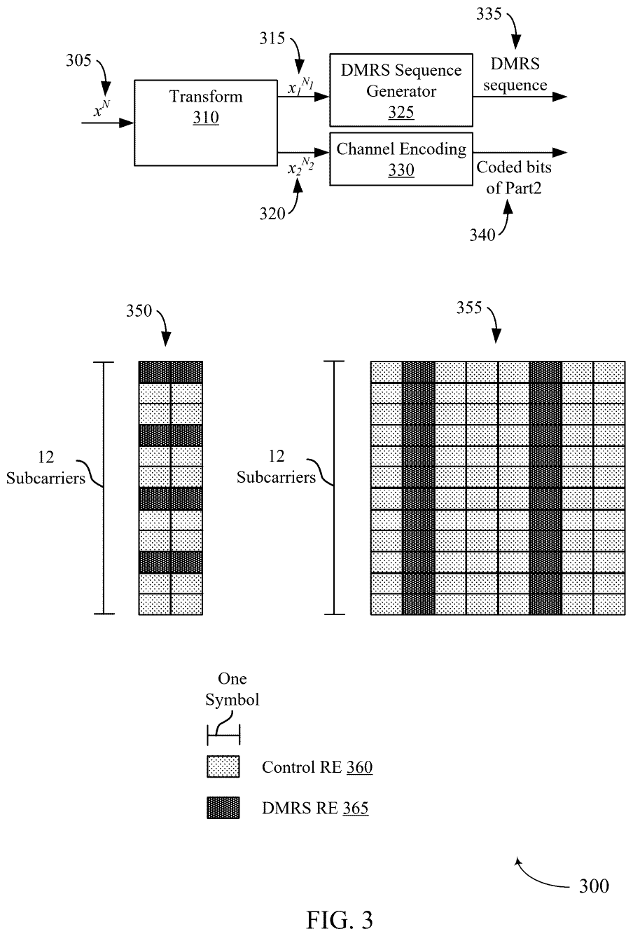

FIG. 3 shows an example of an encoding diagram 300 that supports DMRS-based two-part HARQ feedback in accordance with one or more aspects of the present disclosure. The encoding diagram 300 may implement or may be implemented by aspects of the wireless communications system 100 or the wireless communications system 200.

A UE 115 may generate x^{N} original HARQ feedback bits 305 for one or more downlink transmissions. The UE 115 may use a two-part HARQ feedback transform 310 to transform the x^{N} original HARQ feedback bits 305 into N₁ bits for part one and N₂ bits for part two. For example, the output of the two-part HARQ feedback transform 310 for the x^{N} original HARQ feedback bits 305 may be

$${x}_{1}^{{N}_{1}}$$

bits 315 for part one and

$${x}_{2}^{{N}_{2}}$$

bits 320 for part two. The UL 115 may use a DMRS sequence generator 325 to determine a DMRS sequence based on the

$${x}_{1}^{{N}_{1}}$$

bits 315 for part one and may encode the

$${x}_{2}^{{N}_{2}}$$

bits 320 for part two using channel encoding 330. The output of the DMRS sequence generator 325 may be a DMRS sequence 335. The output of the DMRS sequence generator 325 may be based on a mapping of potential values of part one of the two-part HARQ feedback to different DMRS sequence types, hopping IDs, cyclic shifts, or initialization values as described herein. The output of the channel encoding 330 may be the coded bits of part two 340. The DMRS sequence 335 may be transmitted via DMRS REs 365, and the coded bits of part two 340 may be transmitted via control REs 360 of a PUCCH. For example, the PUCCH may be a PUCCH format 2 350 or a PUCCH format 3/4 355 as shown in FIG. 3. Each RE may include one symbol and one subcarrier. For example, PUCCH format 2 350 may include two symbols and one resource block (RB). PUCCH format 3/4 355 may include eight symbols and one RB.

The network entity 105 which receives the PUCCH (e.g., of either PUCCH format 2 350 or PUCCH formats 3 and/or 4 355) which includes the DMRS sequence 335 and the coded bits of part two 340 may detect which of the 221 DMRS sequences are transmitted. The network entity 105 may also perform channel estimation based on the DMRS sequence transmitted via the DMRS REs 365. The network entity 105 may determine part one of the two-part HARQ-ACK feedback based on the DMRS sequence 335 detected by the network entity 105 (e.g., may determine the

$${x}_{1}^{{N}_{1}}$$

bits 315 for part one). The network entity 105 may determine the size of part two of the two-part HARQ-ACK feedback (e.g., N₂) based on the payload of part one (e.g., based on the

$${x}_{1}^{{N}_{1}}$$

bits 315 determined for part one). Based on the determined size of part two of the two-part HARQ-ACK feedback, the network entity 105 may decode part two of the two-part HARQ-ACK feedback (e.g., may determine the

$${x}_{2}^{{N}_{2}}$$

bits 320 for part two). The network entity 105 may reconstruct the original HARQ-ACK CB using the

$${x}_{1}^{{N}_{1}}$$

bits 315 for part one and the

$${x}_{2}^{{N}_{2}}$$

bits 320 for part two.

In some examples, a mapping may be configured between part one of the two-part HARQ-ACK feedback and a DMRS sequence such that the UE 115 may determine the DMRS sequence based on the value of the part one of the two-part HARQ-ACK feedback, and the network entity 105 may determine the value of the part one of the two-part HARQ-ACK feedback based on the DMRS sequence. In some examples, the mapping may be done per DMRS symbol index, as the DMRS sequence may be a function of time (e.g., symbol index, slot index within a subframe or frame, SFN, or the like) for the purpose of interference randomization.

In some examples, the payload of part one of the two-part HARQ-ACK feedback may be mapped to a base sequence for the DMRS. For example, to determine the base sequence, the payload of part one of the two-part HARQ-ACK feedback may be mapped to a sequence group u or a sequence index within a group v, or both. For example, for a Zadoff-Chu sequence r̅_{u,v}(n) used for PUCCH Format 3 and 4 (as well as for PUCCH Format 0 and 1), u and v determine the base sequence, where there are 30 different sequence groups where u∈{0,1, . . . , 29} indexes a sequence group, and v∈{0, 1} indexes the sequences within a group. The number of sequences per group may depend on the sequence length. For sequences of length longer than 72, there are 2 sequences per group; otherwise, there is only one and v=0.

In some examples, the payload of part one of the two-part HARQ-ACK feedback may be mapped to a cyclic shift applied to the DMRS sequence. For example, the cyclic shift e^{jα}^{ᵢ}ⁿ may be applied to the base sequence r̅_{u,v}(n) for a DMRS, and the cyclic shift may be used to indicate the payload of part one of the two-part HARQ-ACK feedback.

In some examples, the payload of part one of the two-part HARQ-ACK feedback may be mapped to a hopping ID for a DMRS sequence. For sequence or group hopping or for cyclic shift hopping, the hopping ID may be used to determine the initialization of the pseudo-random sequence that is used in the hopping formulae (which itself determines the base sequence or the cyclic shift). Accordingly, the hopping ID may be used to indicate the payload of part one of the two-part HARQ-ACK feedback.

In some examples, the payload of part one of the two-part HARQ-ACK feedback may be mapped to an ID that determines initialization of the DMRS sequence. For example, the ID may be a scrambling ID. For example, the initialization may be a function of the time (e.g., symbol or slot number) in addition to the ID, and the ID may determine the “seed” for a pseudo-random sequence that determines the DMRS sequence. For example, the pseudo-random sequence that determines the DMRS sequence may be given by cᵢₙᵢₜ, and thus the ID may be

$${N}_{ID}^{0} , where {c}_{init} = ( {2}^{17} ( {N}_{symb}^{slot} {n}_{s , f}^{u} + l + 1 ) ( 2 {N}_{ID}^{0} + 1 ) + 2 {N}_{ID}^{0} ) mod ( {2}^{31} ) .$$

For each mapping example, such mapping (e.g., between the payload of part one of the two-part HARQ-ACK feedback and the base sequence, cyclic shift, hopping ID, initialization ID, or scrambling ID) may be pre-configured to the UE 115 (e.g., via control signaling 215 as described with reference to FIG. 2 such as RRC). For example, such control signaling may map each possible payload of part one of the two-part HARQ-ACK feedback to a candidate base sequence, cyclic shift, hopping ID, initialization ID, or scrambling ID. For example, Table 3 shows an example mapping for a 2-bit payload of part one of the two-part HARQ-ACK feedback.

TABLE 3

| Payload of part one of the | base sequence, cyclic shift, hopping ID, |
|---|---|
| two-part HARQ-ACK feedback | initialization ID, or scrambling ID |
| 00 | X |
| 01 | Y |
| 10 | Z |
| 11 | T |

Such configurations may be per CC, per PUCCH configuration, per PUCCH format, and/or per PUCCH resource. Some mappings may be applicable to some PUCCH formats and not other PUCCH formats. For example, the base sequence, cyclic shift, or hopping ID may be used for PUCCH format 3 or 4 and the scrambling ID may be used for PUCCH format 2.

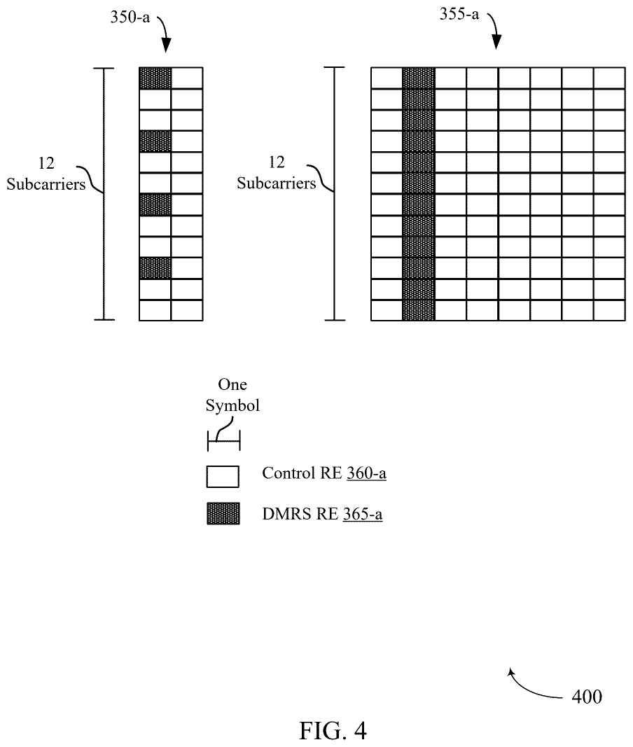

FIG. 4 shows an example of a resource diagram 400 that supports DMRS-based two-part HARQ feedback in accordance with one or more aspects of the present disclosure. The resource diagram 400 may implement or may be implemented by aspects of the wireless communications system 100, the wireless communications system 200 or the encoding diagram 300.

In some examples, the size of the payload of part two of a two-part HARQ feedback may be zero (e.g., N₂=0), depending on the payload of part one of the two-part HARQ feedback. For example, if part one of the two-part HARQ feedback indicates all ACKs, then the size of part two of a two-part HARQ feedback may be zero. In such cases, the UE 115 may not transmit part two of a two-part HARQ feedback, and accordingly, control REs 360-a may not be transmitted in the PUCCH (e.g., PUCCH format 2 350-a or PUCCH format 3/4 355-a). For example, when N₂=0 the UE 115 may only transmit the DMRS REs 365-a and may refrain from transmitting the control REs 360-a.

In some examples, for PUCCH format 2 350-a, the UE 115 may boost the transmission power of the DMRS REs 365-a. In some examples, if the PUCCH resource with the PUCCH format 2 350-a is configured with two symbols, the UE 115 may only transmit the first symbol. In some examples, for PUCCH format 3/4 355-a, the UE 115 may transmit only the first DMRS symbol and may not transmit DMRSs in the remaining symbols of the PUCCH.

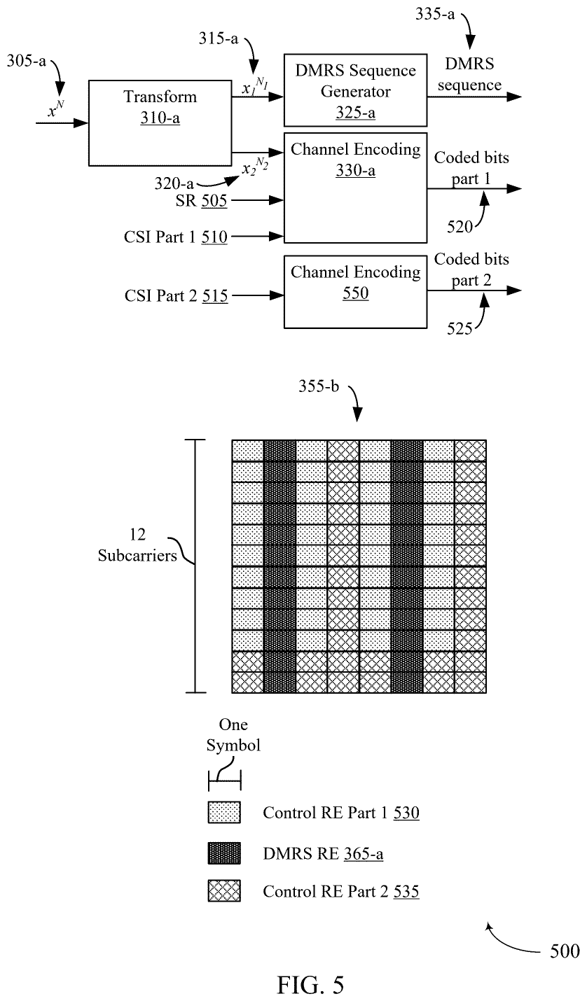

FIG. 5 shows an example of an encoding diagram 500 that supports DMRS-based two-part HARQ feedback in accordance with one or more aspects of the present disclosure. The encoding diagram 500 may implement or may be implemented by aspects of the wireless communications system 100, the wireless communications system 200, or the encoding diagram 300.

In some examples, UCIs such as an SR or a CSI report may be multiplexed on a PUCCH along with two-part HARQ feedback, for example, on a PUCCH format 3/4 355-b. In such cases, a DMRS sequence may be used to indicate part one of the two-part HARQ feedback as described herein. For example, a UE 115 may generate x^{N} original HARQ feedback bits 305-a for one or more downlink transmissions. The UE 115 may use a two-part HARQ feedback transform 310-a to transform the x^{N} original HARQ feedback bits 305 into N₁ bits for part one and N₂ bits for part two. For example, the output of the two-part HARQ feedback transform 310-a for the x^{N} original HARQ feedback bits 305-a may be

$${x}_{1}^{{N}_{1}}$$

bits 315-a for part one and

$${x}_{2}^{{N}_{2}}$$

bits 320-a for part two. The UE 115 may use a DMRS sequence generator 325-a to determine a DMRS sequence based on the

$${x}_{1}^{{N}_{1}}$$

bits 315-a for part one and may encode the

$${x}_{2}^{{N}_{2}}$$

bits 320-a for
part two using channel encoding 330-a. The output of the DMRS sequence generator 325-a may be a DMRS sequence 335-a. The DMRS sequence 335-a may be conveyed via DMRS REs 365-a. The

$${x}_{2}^{{N}_{2}}$$

bits 320-a for part two may be jointly encoded using the channel encoding 330-a with an SR 505 and/or a CSI part one 510. The output of the channel encoding 330-a may be the coded bits part one 520, which may include the coded bits of part two of the two-part HARQ feedback multiplexed with the SR 505 and/or the CSI part one 510.

In a first case, a CSI report, if present, does not have two parts (e.g., the CSI report includes a single part, CSI part one 510). In the first case, the PUCCH may include part one of the two-part HARQ feedback (e.g., indicated by a DMRS sequence 335-a), part two of the two-part HARQ feedback and an SR 505 and/or part one of a CSI report. In the first case, part two of the two-part HARQ feedback and an SR 505 and/or CSI part one 510 may be jointly encoded and transmitted on control REs of the PUCCH.

In a second case, a CSI report may have two parts (e.g., CSI part one 510 and CSI part two 515). In such a case, as shown in FIG. 5, the control REs may be divided into control REs part one 530 and control REs part two 535, which may carry separately encoded UCIs (UCI1 and UCI2). In some examples, as shown in FIG. 5, UCI1 may include part two of the two-part HARQ feedback multiplexed with CSI part one 510 and/or an SR 505. For example, UCI1 (and thus the control REs part one 530) may convey the coded bits part one 520. CSI part two 515 may be encoded using channel encoding 550 to generate coded bits part two 525, which may be conveyed via control REs part two 535. In some examples, UCI1 may include an SR 505 and/or CSI part one 510 and UCI2 may include the part two of the two-part HARQ feedback and the CSI part two 515 (e.g., the part two of the two-part HARQ feedback and the CSI part two 515 may be jointly encoded via the channel encoding 550 and conveyed via the control REs part two 535).

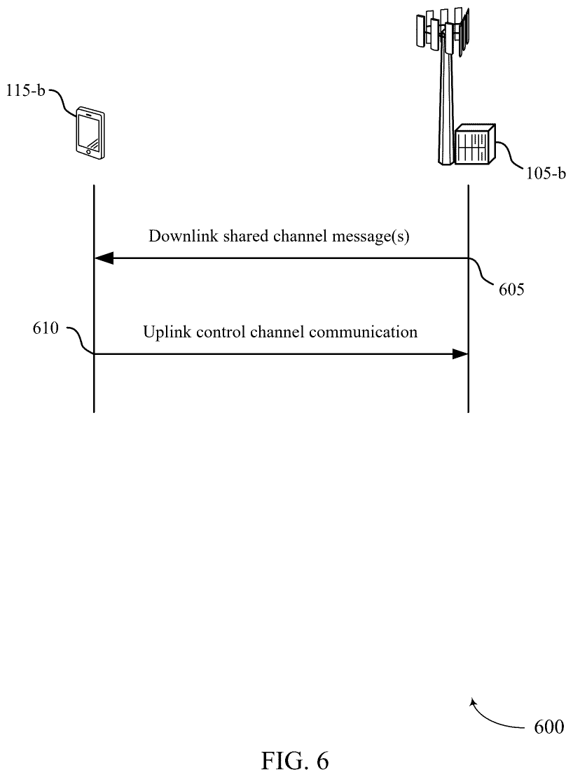

FIG. 6 shows an example of a process flow 600 that supports DMRS-based two-part HARQ feedback in accordance with one or more aspects of the present disclosure. The process flow 600 may include a UE 115-b and a network entity 105-b, which may be examples of a UE 115 and a network entity 105 as described herein. In the following description of the process flow 600, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 600, and other operations may be added to the process flow 600.

At 605, the UE 115-b may receive, from the network entity 105-b, one or more downlink shared channel messages (e.g., one or more PDSCH transmissions).

At 610, the UE 115-b may transmit, to the network entity 105-b, a control message via an uplink control channel communication (e.g., a PUCCH transmission). The uplink control channel communication may include one or more DMRSs in accordance with a DMRS sequence. The DMRS sequence may be indicative of a first part of a two-part HARQ feedback associated with the one or more downlink shared channel messages. The first part of the two-part HARQ feedback may be indicative of a size of a second part of the two-part HARQ feedback.

In some examples, the UE 115-b may transmit, to the network entity 105-b via the control message, the second part of the two-part HARQ feedback. In some examples, transmitting the control message includes transmitting the control message including a set of control REs, where the second part of the two-part HARQ feedback is jointly encoded on the set of control REs with an SR or CSI feedback, or both. In some examples, transmitting the control message includes: transmitting a first part of the control message including a first set of control REs that include the second part of the two-part HARQ feedback, where the second part of the two-part HARQ feedback is jointly encoded on the first set of control REs with an SR or a first part of two-part CSI feedback, or both; and transmitting a second part of the control message including a second set of control REs that include a second part of the two-part CSI feedback. In some examples, transmitting the control message includes: transmitting a first part of the control message including a first set of control REs that include a first part of two-part CSI feedback, where the first part of the two-part CSI feedback is jointly encoded on the first set of control REs with an SR; and transmitting a second part of the control message including a second set of control REs that include the second part of the two-part HARQ feedback, where the second part of the two-part HARQ feedback is jointly encoded on the second set of control REs with a second part of the two-part CSI feedback.

In some examples, the DMRS sequence is indicative of the first part of the two-part HARQ feedback based on the DMRS sequence being a first sequence type of a set of candidate sequence types, having a first cyclic shift of a set of candidate cyclic shifts, having a first hopping ID of a set of candidate hopping IDs, being associated with an initialization ID of a set of candidate initialization IDs, or having a first scrambling ID of a set of candidate scrambling IDs. In some examples, the UE 115-b may receive, from the network entity 105-b (e.g., prior to transmitting the control message at 610), control signaling that indicates a mapping of a set of values associated with the first part of the two-part HARQ feedback to the set of candidate sequence types, the set of candidate cyclic shifts, the set of candidate hopping IDs, the set of candidate initialization IDs, or the set of candidate scrambling IDs, or any combination thereof, and transmission of the control message via the uplink control channel communication is based on the control signaling. In some examples, the control signaling indicates the mapping for a component carrier, for an uplink control channel configuration, for an uplink control channel format, or for an uplink control channel resource, and the uplink control channel communication at 610 is associated with the component carrier, the uplink control channel configuration, the uplink control channel format, or the uplink control channel resource.

In some examples, the UE 115-b may transmit, via the uplink control channel communication, one or more DMRSs via a set of two or more REs separated in frequency from each other by one or more other null REs, where the first part of the two-part HARQ feedback indicates that the size of the second part of the two-part HARQ feedback is zero, and where the set of two or more REs are transmitted using a transmission power that is based on the size of the second part of the two-part HARQ feedback being zero.

In some examples, the UE 115-b may refrain from transmitting a set of control REs in the uplink control channel communication based on the first part of the two-part HARQ feedback indicating that the size of the second part of the two-part HARQ feedback is zero.

In some examples, the UE 115-b may transmit, via the uplink control channel communication, the one or more DMRSs via a set of two or more REs in a same symbol, where the first part of the two-part HARQ feedback indicates that the size of the second part of the two-part HARQ feedback is zero. In some examples, the UE 115-b may refrain from transmitting the one or more DMRSs in a symbol of the uplink control channel communication other than the same symbol based on the size of the second part of the two-part HARQ feedback being zero.

In some examples, using the DMRS sequence to indicate the first part of the two-part HARQ feedback is based on a size of a HARQ feedback codebook associated with the one or more downlink shared channel messages, a size of the first part of the two-part HARQ feedback, one or more resources associated with the uplink control channel communication, a format of the uplink control channel communication, a priority of the HARQ feedback codebook, whether the control message includes an SR, whether the control message includes CSI feedback, or a combination thereof.

In some examples, the UE 115-b may receive, from the network entity 105-b (e.g., prior to transmitting the control message at 610), control signaling that configures the UE 115-b to indicate the first part of the two-part HARQ feedback via the DMRS sequence, and transmission of the control message via the uplink control channel communication may be based on the control signaling.

In some examples, the UE 115-b may transmit, to the network entity 105-b (e.g., prior to transmitting the control message at 610), capability signaling that indicates a capability of the UE 115-b to use the DMRS sequence to indicate the first part of the two-part HARQ feedback, and transmission of the control message via the uplink control channel communication is based on the capability signaling.

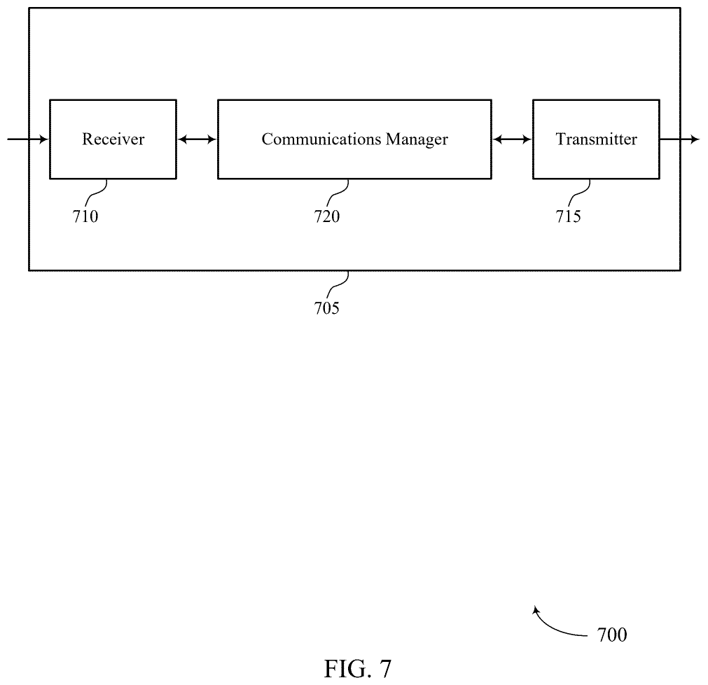

FIG. 7 shows a block diagram 700 of a device 705 that supports DMRS-based two-part HARQ feedback in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to DMRS-based two-part HARQ feedback). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to DMRS-based two-part HARQ feedback). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of DMRS-based two-part HARQ feedback as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving one or more downlink shared channel messages. The communications manager 720 is capable of, configured to, or operable to support a means for transmitting a control message via an uplink control channel communication that includes one or more DMRSs in accordance with a DMRS sequence, where the DMRS sequence is indicative of a first part of a two-part HARQ feedback associated with the one or more downlink shared channel messages, and where the first part of the two-part HARQ feedback is indicative of a size of a second part of the two-part HARQ feedback.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

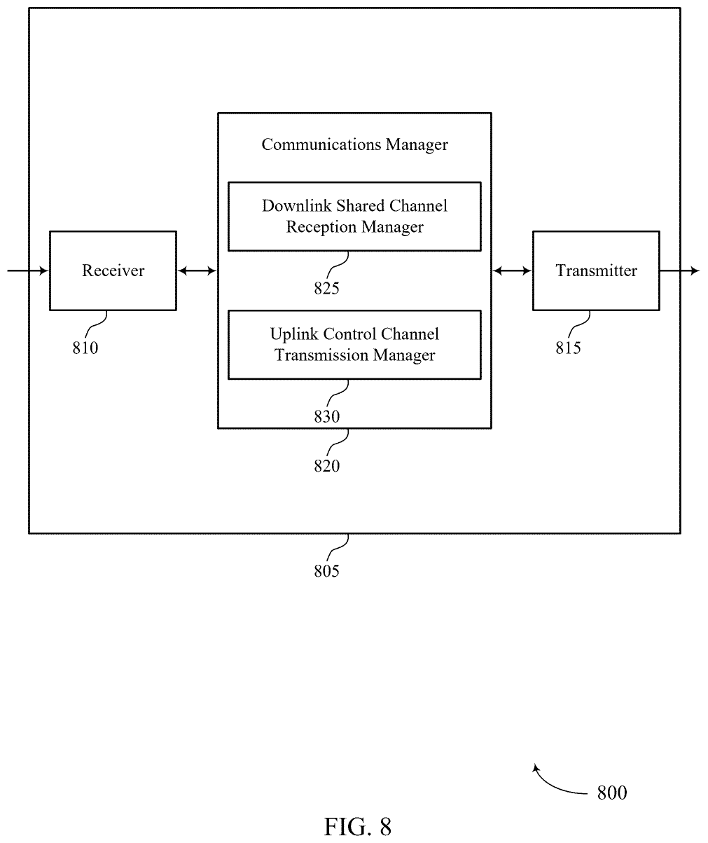

FIG. 8 shows a block diagram 800 of a device 805 that supports DMRS-based two-part HARQ feedback in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to DMRS-based two-part HARQ feedback). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to DMRS-based two-part HARQ feedback). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of DMRS-based two-part HARQ feedback as described herein. For example, the communications manager 820 may include a downlink shared channel reception manager 825 an uplink control channel transmission manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The downlink shared channel reception manager 825 is capable of, configured to, or operable to support a means for receiving one or more downlink shared channel messages. The uplink control channel transmission manager 830 is capable of, configured to, or operable to support a means for transmitting a control message via an uplink control channel communication that includes one or more DMRSs in accordance with a DMRS sequence, where the DMRS sequence is indicative of a first part of a two-part HARQ feedback associated with the one or more downlink shared channel messages, and where the first part of the two-part HARQ feedback is indicative of a size of a second part of the two-part HARQ feedback.

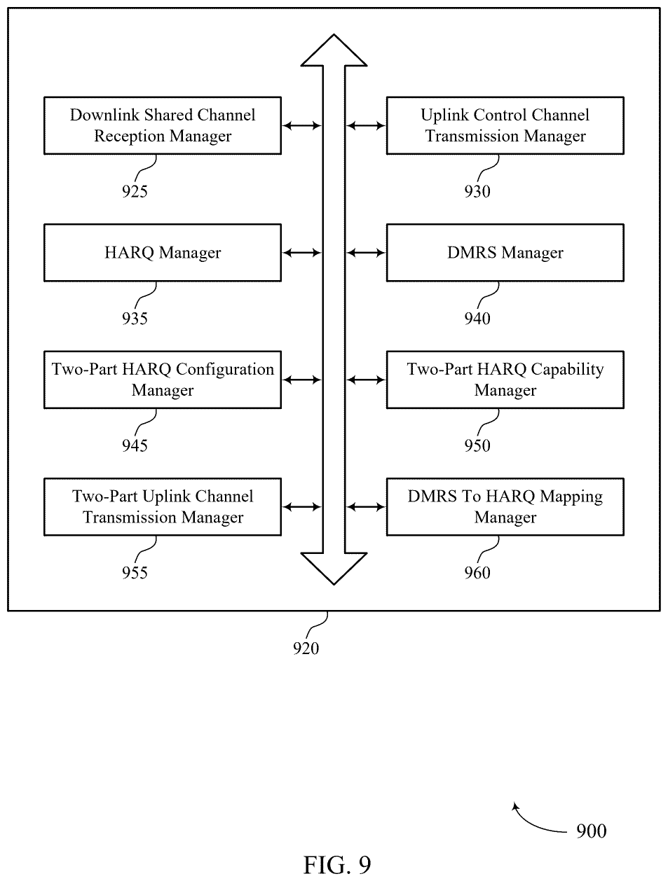

FIG. 9 shows a block diagram 900 of a communications manager 920 that supports DMRS-based two-part HARQ feedback in accordance with one or more aspects of the present disclosure. The communications manager 920 may be an example of aspects of a communications manager 720, a communications manager 820, or both, as described herein. The communications manager 920, or various components thereof, may be an example of means for performing various aspects of DMRS-based two-part HARQ feedback as described herein. For example, the communications manager 920 may include a downlink shared channel reception manager 925, an uplink control channel transmission manager 930, an HARQ manager 935, a DMRS manager 940, a two-part HARQ configuration manager 945, a two-part HARQ capability manager 950, a two-part uplink channel transmission manager 955, a DMRS to HARQ mapping manager 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The downlink shared channel reception manager 925 is capable of, configured to, or operable to support a means for receiving one or more downlink shared channel messages. The uplink control channel transmission manager 930 is capable of, configured to, or operable to support a means for transmitting a control message via an uplink control channel communication that includes one or more DMRSs in accordance with a DMRS sequence, where the DMRS sequence is indicative of a first part of a two-part HARQ feedback associated with the one or more downlink shared channel messages, and where the first part of the two-part HARQ feedback is indicative of a size of a second part of the two-part HARQ feedback.

In some examples, the HARQ manager 935 is capable of, configured to, or operable to support a means for transmitting, via the control message, the second part of the two-part HARQ feedback.

In some examples, to support transmitting the control message, the uplink control channel transmission manager 930 is capable of, configured to, or operable to support a means for transmitting the control message including a set of control REs, where the second part of the two-part HARQ feedback is jointly encoded on the set of control REs with an SR or CSI feedback, or both.

In some examples, to support transmitting the control message, the two-part uplink channel transmission manager 955 is capable of, configured to, or operable to support a means for transmitting a first part of the control message including a first set of control REs that include the second part of the two-part HARQ feedback, where the second part of the two-part HARQ feedback is jointly encoded on the first set of control REs with an SR or a first part of two-part CSI feedback, or both. In some examples, to support transmitting the control message, the two-part uplink channel transmission manager 955 is capable of, configured to, or operable to support a means for transmitting a second part of the control message including a second set of control REs that include a second part of the two-part CSI feedback.

In some examples, to support transmitting the control message, the two-part uplink channel transmission manager 955 is capable of, configured to, or operable to support a means for transmitting a first part of the control message including a first set of control REs that include a first part of two-part CSI feedback, where the first part of the two-part CSI feedback is jointly encoded on the first set of control REs with an SR. In some examples, to support transmitting the control message, the two-part uplink channel transmission manager 955 is capable of, configured to, or operable to support a means for transmitting a second part of the control message including a second set of control REs that include the second part of the two-part HARQ feedback, where the second part of the two-part HARQ feedback is jointly encoded on the second set of control REs with a second part of the two-part CSI feedback.

In some examples, the DMRS sequence is indicative of the first part of the two-part HARQ feedback based on the DMRS sequence being a first sequence type of a set of candidate sequence types, having a first cyclic shift of a set of candidate cyclic shifts, having a first hopping ID of a set of candidate hopping IDs, being associated with an initialization ID of a set of candidate initialization IDs, or having a first scrambling ID of a set of candidate scrambling IDs.

In some examples, the DMRS to HARQ mapping manager 960 is capable of, configured to, or operable to support a means for receiving control signaling that indicates a mapping of a set of values associated with the first part of the two-part HARQ feedback to the set of candidate sequence types, the set of candidate cyclic shifts, the set of candidate hopping IDs, the set of candidate initialization IDs, or the set of candidate scrambling IDs, or any combination thereof, where transmission of the control message via the uplink control channel communication is based on the control signaling.

In some examples, the control signaling indicates the mapping for a component carrier, for an uplink control channel configuration, for an uplink control channel format, or for an uplink control channel resource. In some examples, the uplink control channel communication is associated with the component carrier, the uplink control channel configuration, the uplink control channel format, or the uplink control channel resource.

In some examples, the DMRS manager 940 is capable of, configured to, or operable to support a means for transmitting, via the uplink control channel communication, one or more DMRSs via a set of two or more REs separated in frequency from each other by one or more other null REs, where the first part of the two-part HARQ feedback indicates that the size of the second part of the two-part HARQ feedback is zero, and where the set of two or more REs are transmitted using a transmission power that is based on the size of the second part of the two-part HARQ feedback being zero.

In some examples, the uplink control channel transmission manager 930 is capable of, configured to, or operable to support a means for refraining from transmitting a set of control REs in the uplink control channel communication based on the first part of the two-part HARQ feedback indicating that the size of the second part of the two-part HARQ feedback is zero.

In some examples, the DMRS manager 940 is capable of, configured to, or operable to support a means for transmitting, via the uplink control channel communication, the one or more DMRSs via a set of two or more REs in a same symbol, where the first part of the two-part HARQ feedback indicates that the size of the second part of the two-part HARQ feedback is zero.

In some examples, the uplink control channel transmission manager 930 is capable of, configured to, or operable to support a means for refraining from transmitting the one or more DMRSs in a symbol of the uplink control channel communication other than the same symbol based on the size of the second part of the two-part HARQ feedback being zero.

In some examples, using the DMRS sequence to indicate the first part of the two-part HARQ feedback is based on a size of a HARQ feedback codebook associated with the one or more downlink shared channel messages, a size of the first part of the two-part HARQ feedback, one or more resources associated with the uplink control channel communication, a format of the uplink control channel communication, a priority of the HARQ feedback codebook, whether the control message includes an SR, whether the control message includes CSI feedback, or a combination thereof.

In some examples, the two-part HARQ configuration manager 945 is capable of, configured to, or operable to support a means for receiving control signaling that configures the UE to indicate the first part of the two-part HARQ feedback via the DMRS sequence, where transmission of the control message via the uplink control channel communication is based on the control signaling.

In some examples, the two-part HARQ capability manager 950 is capable of, configured to, or operable to support a means for transmitting capability signaling that indicates a capability of the UE to use the DMRS sequence to indicate the first part of the two-part HARQ feedback, where transmission of the control message via the uplink control channel communication is based on the capability signaling.

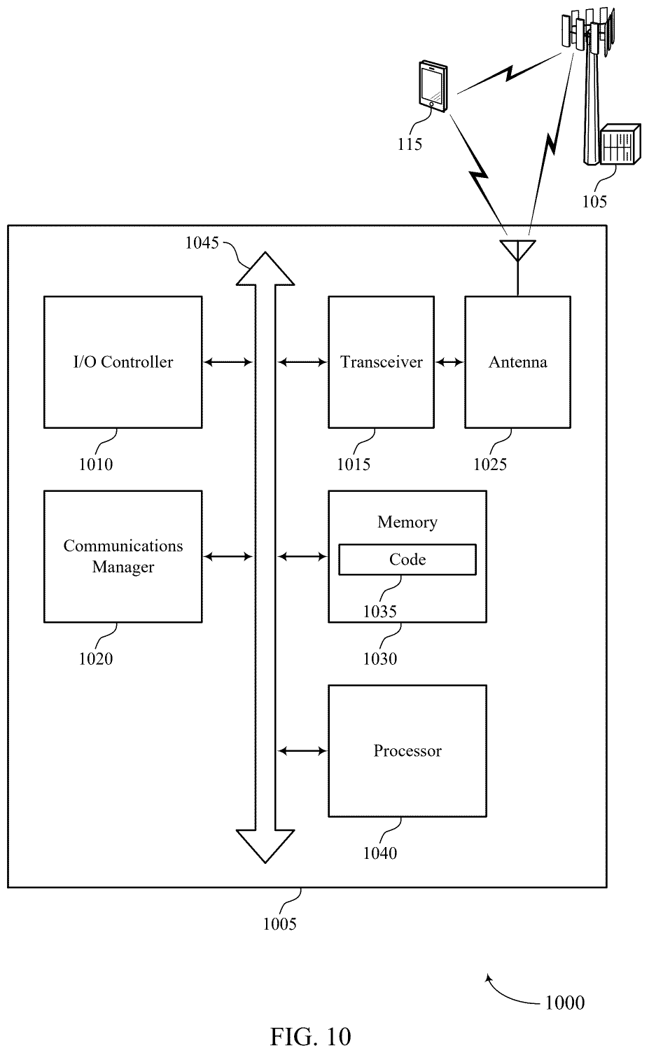

FIG. 10 shows a diagram of a system 1000 including a device 1005 that supports DMRS-based two-part HARQ feedback in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting DMRS-based two-part HARQ feedback). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving one or more downlink shared channel messages. The communications manager 1020 is capable of, configured to, or operable to support a means for transmitting a control message via an uplink control channel communication that includes one or more DMRSs in accordance with a DMRS sequence, where the DMRS sequence is indicative of a first part of a two-part HARQ feedback associated with the one or more downlink shared channel messages, and where the first part of the two-part HARQ feedback is indicative of a size of a second part of the two-part HARQ feedback.

By including or configuring the communications manager 1020 in accordance with examples as described herein, the device 1005 may support techniques for improved communication reliability, reduced latency, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of DMRS-based two-part HARQ feedback as described herein, or the at least one processor 1040 and the at least one memory 1030 may be otherwise configured to, individually or collectively, perform or support such operations.

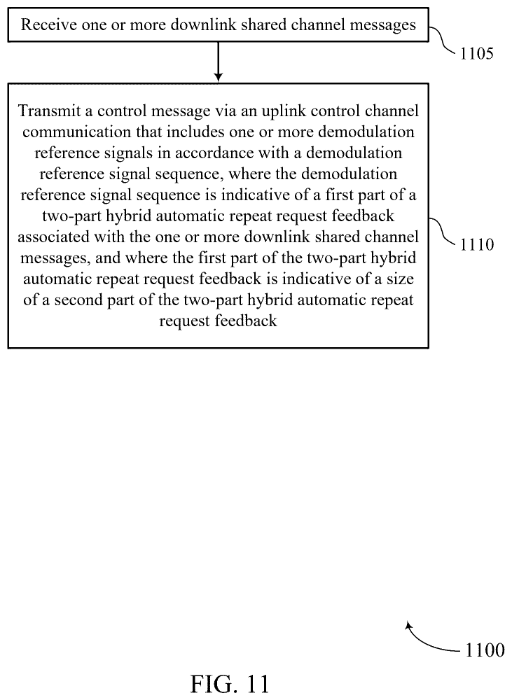

FIG. 11 shows a flowchart illustrating a method 1100 that supports DMRS-based two-part HARQ feedback in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving one or more downlink shared channel messages. The operations of 1105 may be performed in accordance with examples as disclosed herein. In some examples, aspects of the operations of 1105 may be performed by a downlink shared channel reception manager 925 as described with reference to FIG. 9.

At 1110, the method may include transmitting a control message via an uplink control channel communication that includes one or more DMRSs in accordance with a DMRS sequence, where the DMRS sequence is indicative of a first part of a two-part HARQ feedback associated with the one or more downlink shared channel messages, and where the first part of the two-part HARQ feedback is indicative of a size of a second part of the two-part HARQ feedback. The operations of 1110 may be performed in accordance with examples as disclosed herein. In some examples, aspects of the operations of 1110 may be performed by an uplink control channel transmission manager 930 as described with reference to FIG. 9.

The following provides an overview of aspects of the present disclosure:

Aspect 1: A method for wireless communications at a UE, comprising: receiving one or more downlink shared channel messages; and transmitting a control message via an uplink control channel communication that comprises one or more DMRSs in accordance with a DMRS sequence, wherein the DMRS sequence is indicative of a first part of a two-part HARQ feedback associated with the one or more downlink shared channel messages, and wherein the first part of the two-part HARQ feedback is indicative of a size of a second part of the two-part HARQ feedback.

Aspect 2: The method of aspect 1, further comprising: transmitting, via the control message, the second part of the two-part HARQ feedback.

Aspect 3: The method of aspect 2, wherein transmitting the control message comprises: transmitting the control message comprising a set of control REs, wherein the second part of the two-part HARQ feedback is jointly encoded on the set of control REs with a SR or CSI feedback, or both.

Aspect 4: The method of any of aspects 2 through 3, wherein transmitting the control message comprises: transmitting a first part of the control message comprising a first set of control REs that include the second part of the two-part HARQ feedback, wherein the second part of the two-part HARQ feedback is jointly encoded on the first set of control REs with a SR or a first part of two-part CSI feedback, or both; and transmitting a second part of the control message comprising a second set of control REs that include a second part of the two-part CSI feedback.

Aspect 5: The method of any of aspects 2 through 3, wherein transmitting the control message comprises: transmitting a first part of the control message comprising a first set of control REs that include a first part of two-part CSI feedback, wherein the first part of the two-part CSI feedback is jointly encoded on the first set of control REs with a SR; and transmitting a second part of the control message comprising a second set of control REs that include the second part of the two-part HARQ feedback, wherein the second part of the two-part HARQ feedback is jointly encoded on the second set of control REs with a second part of the two-part CSI feedback.

Aspect 6: The method of any of aspects 1 through 5, wherein the DMRS sequence is indicative of the first part of the two-part HARQ feedback based at least in part on the DMRS sequence being a first sequence type of a set of candidate sequence types, having a first cyclic shift of a set of candidate cyclic shifts, having a first hopping identifier of a set of candidate hopping identifiers, being associated with an initialization identifier of a set of candidate initialization identifiers, or having a first scrambling identifier of a set of candidate scrambling identifiers.

Aspect 7: The method of aspect 6, further comprising: receiving control signaling that indicates a mapping of a set of values associated with the first part of the two-part HARQ feedback to the set of candidate sequence types, the set of candidate cyclic shifts, the set of candidate hopping identifiers, the set of candidate initialization identifiers, or the set of candidate scrambling identifiers, or any combination thereof, wherein transmission of the control message via the uplink control channel communication is based at least in part on the control signaling.

Aspect 8: The method of aspect 7, wherein the control signaling indicates the mapping for a component carrier, for an uplink control channel configuration, for an uplink control channel format, or for an uplink control channel resource, and the uplink control channel communication is associated with the component carrier, the uplink control channel configuration, the uplink control channel format, or the uplink control channel resource.

Aspect 9: The method of any of aspect 1 or aspects 6 through 8, further comprising: transmitting, via the uplink control channel communication, the one or more DMRSs via a set of two or more REs separated in frequency from each other by one or more other null REs, wherein the first part of the two-part HARQ feedback indicates that the size of the second part of the two-part HARQ feedback is zero, and wherein the set of two or more REs are transmitted using a transmission power that is based at least in part on the size of the second part of the two-part HARQ feedback being zero.

Aspect 10: The method of any of aspect 1 or aspects 6 through 9, further comprising: refraining from transmitting a set of control REs in the uplink control channel communication based at least in part on the first part of the two-part HARQ feedback indicating that the size of the second part of the two-part HARQ feedback is zero.

Aspect 11: The method of any of aspect 1 or aspects 6 through 10, further comprising: transmitting, via the uplink control channel communication, the one or more DMRSs via a set of two or more REs in a same symbol, wherein the first part of the two-part HARQ feedback indicates that the size of the second part of the two-part HARQ feedback is zero.

Aspect 12: The method of aspect 11, further comprising: refraining from transmitting the one or more DMRSs in a symbol of the uplink control channel communication other than the same symbol based at least in part on the size of the second part of the two-part HARQ feedback being zero.

Aspect 13: The method of any of aspects 1 through 12, wherein using the DMRS sequence to indicate the first part of the two-part HARQ feedback is based at least in part on a size of a HARQ feedback codebook associated with the one or more downlink shared channel messages, a size of the first part of the two-part HARQ feedback, one or more resources associated with the uplink control channel communication, a format of the uplink control channel communication, a priority of the HARQ feedback codebook, whether the control message includes a SR, whether the control message includes CSI feedback, or a combination thereof.

Aspect 14: The method of any of aspects 1 through 13, further comprising: receiving control signaling that configures the UE to indicate the first part of the two-part HARQ feedback via the DMRS sequence, wherein transmission of the control message via the uplink control channel communication is based at least in part on the control signaling.

Aspect 15: The method of any of aspects 1 through 14, further comprising: transmitting capability signaling that indicates a capability of the UE to use the DMRS sequence to indicate the first part of the two-part HARQ feedback, wherein transmission of the control message via the uplink control channel communication is based at least in part on the capability signaling.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more downlink shared channel messages; and
transmit a control message via an uplink control channel communication that comprises one or more demodulation reference signals in accordance with a demodulation reference signal sequence, wherein the demodulation reference signal sequence is indicative of a first part of a two-part hybrid automatic repeat request feedback associated with the one or more downlink shared channel messages, and wherein the first part of the two-part hybrid automatic repeat request feedback is indicative of a size of a second part of the two-part hybrid automatic repeat request feedback.

2. The UE of claim 1, wherein the one or more processors are individually or collectively further operable to execute the code to cause the UE to:
transmit, via the control message, the second part of the two-part hybrid automatic repeat request feedback.

3. The UE of claim 2, wherein, to transmit the control message, the one or more processors are individually or collectively operable to execute the code to cause the UE to:
transmit the control message comprising a set of control resource elements, wherein the second part of the two-part hybrid automatic repeat request feedback is jointly encoded on the set of control resource elements with a scheduling request or channel state information feedback, or both.

4. The UE of claim 2, wherein, to transmit the control message, the one or more processors are individually or collectively operable to execute the code to cause the UE to:
transmit a first part of the control message comprising a first set of control resource elements that include the second part of the two-part hybrid automatic repeat request feedback, wherein the second part of the two-part hybrid automatic repeat request feedback is jointly encoded on the first set of control resource elements with a scheduling request or a first part of two-part channel state information feedback, or both; and
transmit a second part of the control message comprising a second set of control resource elements that include a second part of the two-part channel state information feedback.

5. The UE of claim 2, wherein, to transmit the control message, the one or more processors are individually or collectively operable to execute the code to cause the UE to:
transmit a first part of the control message comprising a first set of control resource elements that include a first part of two-part channel state information feedback, wherein the first part of the two-part channel state information feedback is jointly encoded on the first set of control resource elements with a scheduling request; and
transmit a second part of the control message comprising a second set of control resource elements that include the second part of the two-part hybrid automatic repeat request feedback, wherein the second part of the two-part hybrid automatic repeat request feedback is jointly encoded on the second set of control resource elements with a second part of the two-part channel state information feedback.

6. The UE of claim 1, wherein the demodulation reference signal sequence is indicative of the first part of the two-part hybrid automatic repeat request feedback based at least in part on the demodulation reference signal sequence being a first sequence type of a set of candidate sequence types, having a first cyclic shift of a set of candidate cyclic shifts, having a first hopping identifier of a set of candidate hopping identifiers, being associated with an initialization identifier of a set of candidate initialization identifiers, or having a first scrambling identifier of a set of candidate scrambling identifiers.

7. The UE of claim 6, wherein the one or more processors are individually or collectively further operable to execute the code to cause the UE to:
receive control signaling that indicates a mapping of a set of values associated with the first part of the two-part hybrid automatic repeat request feedback to the set of candidate sequence types, the set of candidate cyclic shifts, the set of candidate hopping identifiers, the set of candidate initialization identifiers, or the set of candidate scrambling identifiers, or any combination thereof, wherein transmission of the control message via the uplink control channel communication is based at least in part on the control signaling.

8. The UE of claim 7, wherein:
the control signaling indicates the mapping for a component carrier, for an uplink control channel configuration, for an uplink control channel format, or for an uplink control channel resource, and
the uplink control channel communication is associated with the component carrier, the uplink control channel configuration, the uplink control channel format, or the uplink control channel resource.

9. The UE of claim 1, wherein the one or more processors are individually or collectively further operable to execute the code to cause the UE to:
transmit, via the uplink control channel communication, the one or more demodulation reference signals via a set of two or more resource elements separated in frequency from each other by one or more other null resource elements, wherein the first part of the two-part hybrid automatic repeat request feedback indicates that the size of the second part of the two-part hybrid automatic repeat request feedback is zero, and wherein the set of two or more resource elements are transmitted using a transmission power that is based at least in part on the size of the second part of the two-part hybrid automatic repeat request feedback being zero.

10. The UE of claim 1, wherein the one or more processors are individually or collectively further operable to execute the code to cause the UE to:
refrain from transmitting a set of control resource elements in the uplink control channel communication based at least in part on the first part of the two-part hybrid automatic repeat request feedback indicating that the size of the second part of the two-part hybrid automatic repeat request feedback is zero.

11. The UE of claim 1, wherein the one or more processors are individually or collectively further operable to execute the code to cause the UE to:
transmit, via the uplink control channel communication, the one or more demodulation reference signals via a set of two or more resource elements in a same symbol, wherein the first part of the two-part hybrid automatic repeat request feedback indicates that the size of the second part of the two-part hybrid automatic repeat request feedback is zero.

12. The UE of claim 11, wherein the one or more processors are individually or collectively further operable to execute the code to cause the UE to:
refrain from transmitting the one or more demodulation reference signals in a symbol of the uplink control channel communication other than the same symbol based at least in part on the size of the second part of the two-part hybrid automatic repeat request feedback being zero.

13. The UE of claim 1, wherein using the demodulation reference signal sequence to indicate the first part of the two-part hybrid automatic repeat request feedback is based at least in part on a size of a hybrid automatic repeat request feedback codebook associated with the one or more downlink shared channel messages, a size of the first part of the two-part hybrid automatic repeat request feedback, one or more resources associated with the uplink control channel communication, a format of the uplink control channel communication, a priority of the hybrid automatic repeat request feedback codebook, whether the control message includes a scheduling request, whether the control message includes channel state information feedback, or a combination thereof.

14. The UE of claim 1, wherein the one or more processors are individually or collectively further operable to execute the code to cause the UE to:
receive control signaling that configures the UE to indicate the first part of the two-part hybrid automatic repeat request feedback via the demodulation reference signal sequence, wherein transmission of the control message via the uplink control channel communication is based at least in part on the control signaling.

15. The UE of claim 1, wherein the one or more processors are individually or collectively further operable to execute the code to cause the UE to:
transmit capability signaling that indicates a capability of the UE to use the demodulation reference signal sequence to indicate the first part of the two-part hybrid automatic repeat request feedback, wherein transmission of the control message via the uplink control channel communication is based at least in part on the capability signaling.

16. A method for wireless communications at a user equipment (UE), comprising:
receiving one or more downlink shared channel messages; and
transmitting a control message via an uplink control channel communication that comprises one or more demodulation reference signals in accordance with a demodulation reference signal sequence, wherein the demodulation reference signal sequence is indicative of a first part of a two-part hybrid automatic repeat request feedback associated with the one or more downlink shared channel messages, and wherein the first part of the two-part hybrid automatic repeat request feedback is indicative of a size of a second part of the two-part hybrid automatic repeat request feedback.

17. The method of claim 16, further comprising:
transmitting, via the control message, the second part of the two-part hybrid automatic repeat request feedback.

18. The method of claim 17, wherein transmitting the control message comprises:
transmitting the control message comprising a set of control resource elements, wherein the second part of the two-part hybrid automatic repeat request feedback is jointly encoded on the set of control resource elements with a scheduling request or channel state information feedback, or both.

19. The method of claim 17, wherein transmitting the control message comprises:
transmitting a first part of the control message comprising a first set of control resource elements that include the second part of the two-part hybrid automatic repeat request feedback, wherein the second part of the two-part hybrid automatic repeat request feedback is jointly encoded on the first set of control resource elements with a scheduling request or a first part of two-part channel state information feedback, or both; and
transmitting a second part of the control message comprising a second set of control resource elements that include a second part of the two-part channel state information feedback.

20. A non-transitory computer-readable medium storing code for wireless communications, the code comprising instructions executable by one or more processors to:
receive one or more downlink shared channel messages; and
transmit a control message via an uplink control channel communication that comprises one or more demodulation reference signals in accordance with a demodulation reference signal sequence, wherein the demodulation reference signal sequence is indicative of a first part of a two-part hybrid automatic repeat request feedback associated with the one or more downlink shared channel messages, and wherein the first part of the two-part hybrid automatic repeat request feedback is indicative of a size of a second part of the two-part hybrid automatic repeat request feedback.
